(19) United States
(12) Patent Application Publication
(10) Pub. No.: US 2014/0170437 A1
(43) Pub. Date: Jun. 19, 2014

(54) METHOD OF APPLYING ZINC COMPLEX FILM, METHOD OF COATING A BRAKE CALIPER, AND BRAKE CALIPER THUS FORMED

(71) Applicant: HYUNDAI MOTOR COMPANY, Seoul (KR)

(72) Inventor: Sang Soo Kim, Anyang (KR)

(73) Assignee: HYUNDAI MOTOR COMPANY, Seoul (KR)

(21) Appl. No.: 13/828,257

(22) Filed: Mar. 14, 2013

(30) Foreign Application Priority Data
Dec. 14, 2012 (KR) 10-2012-0146844

(51) Int. Cl. F16D 65/00; B05D 3/06

(52) U.S. Cl. CPC F16D 65/0025; B05D 3/06
USPC 428/658; 427/559

(57) ABSTRACT

Disclosed is a method of applying a zinc complex film, including forming a zinc complex film on a surface of a substrate, performing high-frequency curing at about 90˜110° C. for about 18˜22 min, and performing painting and drying as post-treatment. Further disclosed are a method of coating a brake caliper using the zinc complex film, and to a brake caliper thus coated.

### CROSS-REFERENCE TO RELATED APPLICATION

This application claims under 35 U.S.C. §119(a) the benefit of Korean Patent Application No. 10-2012-0146844 filed Dec. 14, 2012 the entire contents of which are incorporated herein by reference.

### BACKGROUND OF THE INVENTION

1. Field of the Invention

The present invention relates to a method of applying a zinc complex film, that provides improved adhesion between a surface of a brake caliper and a surface treatment coating, a method of coating a brake caliper, and a brake caliper thus coated.

2. Description of the Related Art

A brake caliper is conventionally treated with zinc plating and colored chromate, but such a brake caliper has low corrosion resistance and poor color. As such, surface treatment methods capable of solving such problems are currently being developed. In particular, it is generally possible to improve corrosion resistance and exhibit superior color by coating with a zinc complex film followed by black coating post-treatment using a composition including an epoxy modified resin, urethane, carbon black and talc.

Upon actual fabrication of products, however, it is difficult to ensure adhesion between a surface of a brake caliper using a cast material and a surface treatment coating. As such, an undesirable result of such treatment is premature stripping of the coating and poor corrosion resistance.

A black coating treatment using an epoxy modified resin following coating with a zinc complex film, corresponding to the a surface treatment for a caliper, may be carried out as follows.

Pretreatment (degreasing/derusting)→coating with a zinc complex film (spray or dipping type)→black post-treatment→drying (300° C., 10 min)

However, because almost all calipers that are mass produced are currently formed using a cast material, surface roughness of such calipers is not uniform. As a result, small pinholes are present on the surface of parts upon casting. When such a cast part is subsequently coated, a coating is formed in a state in which gas does not sufficiently escape from the inside of the pinholes. This residual gas acts as a main cause of deterioration in the adhesion of the coating and the corrosion resistance.

Korean Unexamined Patent Application Publication No. 10-2012-0054851 (KR10-2012-0054851 A), entitled “Color coating caliper and color surface treatment method thereof,” sets out that “The present invention relates to a color coating caliper and a color surface treatment method thereof, and, more particularly, to a color coating caliper and a color surface treatment method thereof, in which a base coating layer and a color coating layer are formed on a caliper substrate, thus showing a black color, a blue color, etc., and exhibiting superior corrosion resistance. In the color surface-treated caliper and the color surface treatment method thereof according to the present invention, corrosion resistance is increased by 25% or more, and it is possible to represent colors such as black, blue, etc., which are conventionally difficult to show, thus increasing productivity, compared to conventional zinc plating treatment. Also, the treatment process according to the present invention is simplified and the number of processes may decrease, compared to conventional zinc plating, and furthermore, environmental pollution due to wastewater which is byproduced in the conventional plating process may be prevented.”

Nevertheless, there is no specific description of the heat treatment procedure, and thus problems of deteriorating anti-rust performance due to subsequent stripping still remain.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems encountered in the related art, and an object of the present invention is to provide a method of applying a zinc complex film, which solves problems of premature stripping of a coating and poor corrosion resistance. Such problems generally result from a difficulty of ensuring adhesion between a surface of a brake caliper and a surface treatment coating. The present invention further provides a method of coating a brake caliper, and a brake caliper thus coated.

According to one aspect the present invention provides a method of applying a zinc complex film, including forming a zinc complex film on a surface of a substrate; performing high-frequency curing at about 90˜110° C. for about 18˜22 min; and performing painting or coating and drying as post-treatment processes.

According to various embodiments, the post-treatment is performed by conducting drying at about 300˜350° C. for about 13˜17 min.

According to various embodiments, the substrate is manufactured using a casting process.

According to a further aspect, the present invention provides a method of coating a brake caliper, including forming a zinc complex film on a surface of the brake caliper; performing high-frequency curing at about 90˜110° C. for about 18˜22 min; and performing painting or coating and drying as post-treatment processes.

According to various embodiments, the brake caliper is manufactured using a casting process.

According to a further aspect, the present invention provides a brake caliper, which is coated using the described coating method including forming a zinc complex film on a surface of a brake caliper; performing high-frequency curing at about 90˜110° C. for about 18˜22 min; and performing painting or coating and drying as post-treatment processes.

Other aspects and exemplary embodiments of the invention are discussed infra.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart illustrating a process of coating a brake caliper according to an embodiment of the present invention;

FIG. 2 is a graph illustrating the effects of the process of coating a brake caliper according to an embodiment of the present invention;

FIG. 3 is a table illustrating anti-rust effects of a brake caliper according to an embodiment of the present invention;

FIG. 4 is a perspective view illustrating the brake caliper according to an embodiment of the present invention; and

FIG. 5 is a view illustrating the surface of the brake caliper according to an embodiment of the present invention, after adhesion testing;

### DESCRIPTION OF SPECIFIC EMBODIMENTS

Hereinafter, a detailed description will be given of a method of applying a zinc complex film, a method of coating a brake caliper, and a brake caliper according to preferred embodiments of the present invention with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

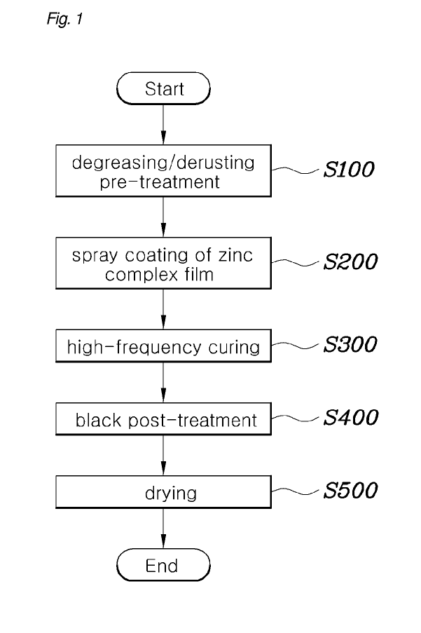

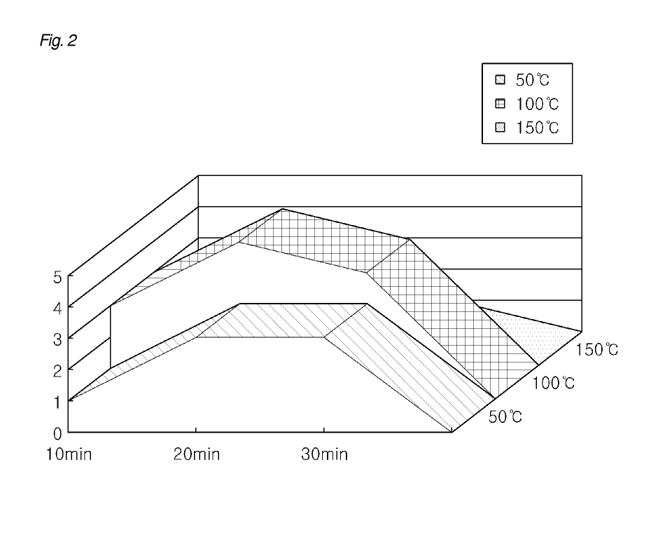

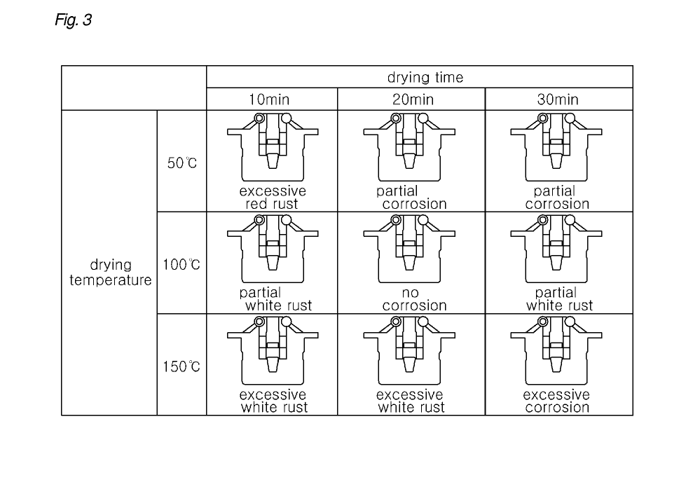

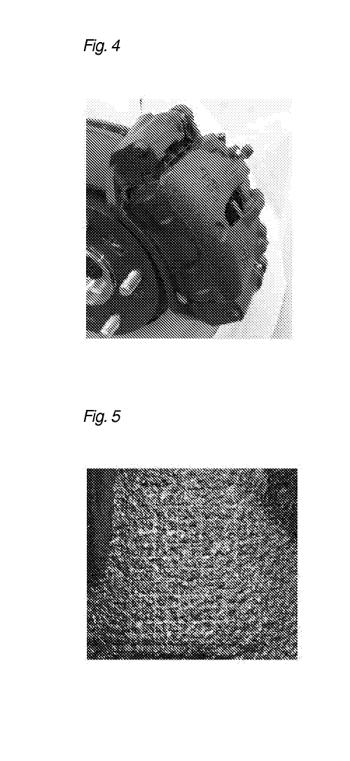

FIG. 1 is a flowchart illustrating a process of coating a brake caliper according to an embodiment of the present invention, FIG. 2 is a graph illustrating the effects of the process of coating a brake caliper according to an embodiment of the present invention, FIG. 3 is a table illustrating anti-rust effects of a brake caliper according to an embodiment of the present invention, FIG. 4 is a perspective view illustrating the brake caliper according to an embodiment of the present invention, and FIG. 5 is a view illustrating the surface of the brake caliper according to an embodiment of the present invention, after adhesion testing;

According to the present invention, a method of applying a zinc complex film may solve conventional problems of premature stripping of a coating and poor corrosion resistance that typically results from a difficulty of ensuring adhesion between a surface of a brake caliper and a surface treatment coating. According to an embodiment of the present invention as shown in FIG. 1, the coating method generally includes forming a zinc complex film on the surface of a substrate (S200); performing high-frequency curing (S300); and performing painting and drying (S400, S500) as post-treatment.

In addition, a method of coating a brake caliper according to a specific embodiment of the present invention includes forming a zinc complex film on the surface of a brake caliper (S200); performing high-frequency curing at about 90˜110° C. for about 18˜22 min (S300); and performing painting and drying (S400, S500) as post-treatment.

According to the present invention, the brake caliper may be manufactured using a casting process, and it may be effectively enhanced in terms of adhesion and anti-rust performance against small pinholes that are typically formed on its surface due to casting.

According to an exemplary embodiment, drying is carried out at about 300˜350° C. for about 13˜17 min.

FIG. 1 is a flowchart illustrating the process of coating the brake caliper according to the present invention, which includes performing degreasing and derusting of a cast caliper (S100) as a pre-treatment process.

Subsequently, the surface of the product is treated with a zinc complex film, which can be accomplished using any process known to form a film, (S200).

In particular, according to embodiments of the present invention, high-frequency curing (S300) is performed after treatment with the zinc complex film (S200), thereby solving conventional problems of poor coating adhesion due to the residual gas that remains in small pinholes that are formed on the surface of the cast caliper (S300).

In particular, according to the present invention, when high-frequency curing (S300) is performed, gas remaining in the pinholes may be easily dried and removed from the uncured zinc complex film, thereby solving conventional problems of poor coating adhesion due to the pinholes.

Subsequently, as post-treatment processes, a black coating is formed using a spray (S400) followed by drying. For example, drying (S500) can be is conducted at about 300˜350° C. for about 13˜17 min. If the drying time or temperature is too low, it becomes more difficult to achieve sufficient drying. In contrast, if the drying time or temperature is too high, cracking or stripping may result due to excessive drying.

FIG. 2 illustrates the effects of the process of coating the brake caliper according to an embodiment of the present invention. As illustrated in FIG. 2, in the case where high-frequency curing at 90˜110° C. is carried out for 18˜22 min, excellent corrosion resistance is provided.

FIG. 3 illustrates anti-rust effects of the brake caliper according to an embodiment of the present invention.

In particular, the table in FIG. 3 shows the corrosion state of the brake caliper after a variety of surface treatment processes. The corrosion grades are classified into 1˜5, in which the grade 5 indicates the worst state. As is apparent from this table, in the case where high-frequency curing is carried out at 90˜110° C. for 18˜22 min, corrosion is not generated upon anti-rust testing.

If the curing temperature is lower than about 90° C., it is difficult to completely dry gas in the pinholes. As a result, it becomes difficult to solve the problem of poor adhesion. In contrast, if the temperature is higher than about 110° C., the zinc complex film may be baked too quickly, undesirably causing poor adhesion upon post-treatment.

Also, if the curing time is shorter than about 18 min, it is difficult to completely remove gas from the pinholes. In contrast, if the curing time is longer than about 22 min, then the zinc complex film may be excessively cured, which can cause microcracking, etc., undesirably resulting in decreased corrosion resistance.

Therefore, high-frequency curing at about 100° C. for about 20 min is regarded as optimal in terms of attaining desired coating adhesion and maximizing corrosion resistance.

FIG. 4 is a perspective view illustrating the brake caliper according to an embodiment of the present invention, and FIG. 5 illustrates the surface of the brake caliper according to the embodiment of the present invention, after adhesion testing. When the caliper manufactured by the method according to the present invention is subjected to an anti-rust durability test (SST: Saline Spray Test) for 500 hr or longer, good results are obtained without generation of red rust. The adhesion of an initial coating is regarded as good, without stripping at M-1.5 or less as in the checkerboard test results, from which the adhesion is evaluated to be remarkably increased.

In the method of applying the zinc complex film having the above structure, the method of coating the brake caliper, and the brake caliper thus formed according to the present invention, a decrease in coating adhesion that typically results from gas remaining in small pinholes on the surface of the caliper is prevented.

The present invention makes this possible by drying the gas that remains in the pinholes from the uncured zinc complex film using the described curing process.

AS such, when the adhesion is increased in this way, premature corrosion of the caliper coating is prevented, and, compared to conventional products, corrosion resistance is increased at least three times. Further, coating adhesion is drastically enhanced.

As described hereinbefore, the present invention provides a method of applying a zinc complex film, a method of coating a brake caliper, and a brake caliper thus coated. According to the present invention, coating adhesion is maintained rather than decreased by reducing or eliminating residual gas in the small pinholes that are formed on the surface of the caliper.

In particular, this is accomplished by drying residual gas in the pinholes from an uncured zinc complex film using a curing process according to the present invention.

As adhesion is enhanced, premature corrosion of the caliper coating, which occurs with conventional caliper coatings, can be prevented. Further, compared to conventional products, corrosion resistance of the present coated calipers can be increased at least three times, and coating adhesion can be drastically enhanced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of applying a zinc complex film, comprising:
forming a zinc complex film on a surface of a substrate;
performing high-frequency curing at about 90˜110° C. for about 18˜22 min; and
performing painting or coating and drying as post-treatment.

2. The method of claim 1, wherein the post-treatment is performed by conducting drying at about 300˜350° C. for about 13˜17 min.

3. The method of claim 1, wherein the substrate is manufactured using a casting process.

4. A method of coating a brake caliper, comprising:
forming a zinc complex film on a surface of a brake caliper;
performing high-frequency curing at about 90˜110° C. for about 18˜22 min; and
performing painting or coating and drying as post-treatment.

5. The method of claim 4, wherein the brake caliper is manufactured using a casting process.

6. A brake caliper, coated using the method of claim 4.
